(19) United States
(12) Patent Application Publication
(10) Pub. No.: US 2005/0276891 A1
(43) Pub. Date: Dec. 15, 2005

(54) Use of colloidal anionic silica sols as clarifying agents

(76) Inventors: Uwe Falk, Bruchkoebel (DE); Eric Jacquinot, Trosly-Breuil (FR); Marie-Laure Perard, Compiegne (FR)

Correspondence Address: AZ ELECTRONIC MATERIALS USA CORP.;ATTENTION: INDUSTRIAL PROPERTY DEPT., 70 MEISTER AVENUE, SOMERVILLE, NJ, 08876, US

(21) Appl. No.: 10/518,315

(22) PCT Filed: Jun. 13, 2003
(86) PCT No.: PCT/EP03/06264

§ 371 Date: Dec. 16, 2004

(30) Foreign Application Priority Data
Jun. 28, 2002 (DE) 102 29 047.4

(51) Int. Cl. C12H 1/04

(52) U.S. Cl. 426/422

(57) ABSTRACT

The invention relates to the use of colloidal, anionic silica sols of a pH of 1 to 5.5, a particle diameter of 4 to 150 nm and a surface area of 20 to 700 m²/g for clarifying and stabilizing liquid foods.

The present invention relates to the use of colloidal anionic silica sols of acid pH for clarifying and stabilizing liquid food.

Liquid food such as fruit juices, beers and wines generally occur in cloudy form during their production. The cloud consists of constituents of the plants from which the foods were produced which were not removed by filtration, or, as in the case of beer, of yeast.

Consumers prize this cloud only in exceptional cases. Generally consumers want a clear product. The production of a clear beer is a particular problem. Beer, even when it was produced in clear form, can become cloudy during storage.

DE-A-16 42 769 discloses that finely divided precipitated silica sols in beer have a stabilizing action which can essentially be explained by selective adsorption of high-molecular-weight protein substances which are responsible for cloud formation. It is further known to use polyvinylpyrrolidone for beer stabilization, in which case the action is due to adsorption of polyphenolic components (tannin and anthocyanogen). DE-A-16 42 769 discloses an agent for beer clarification which consists of acid-precipitated silica sol from silicate solutions, organic-polymer-modified, in the presence of water-soluble polyvinylpyrrolidone or derivatives thereof or mixed polymers. Suitable organic polymer components are, in addition to the abovementioned polyvinylpyrrolidone, for example polyvinyl-3-methylpyrrolidone and the corresponding mixed polymers with vinyl acetate.

U.S. Pat. No. 3,617,301 discloses a process for clarifying beer which comprises adding hydrogels having a surface area of at least 700 m²/g and a mean pore diameter of 3 to 12 nm to the beer, and their subsequent removal.

U.S. Pat. No. 3,878,300 discloses a process for clarifying beer which comprises adding 50 to 500 ppm of a silica sol hydrosol. The hydrosol is produced by aging and ion exchange.

Starting from the prior art, the object of the present invention was to improve the known processes for clarifying and stabilizing liquid food. In addition, the product used for the clarification should be easy to handle.

Surprisingly, it has now been found that a colloidal anionic silica sol of acid pH is an excellent agent for clarifying and stabilizing liquid foods.

The invention thus relates to the use of colloidal anionic silica sols of a pH from 1 to 5.5, a particle diameter of 4 to 150 nm and a surface area of 20 to 700 m²/g for clarifying and stabilizing liquid foods.

The invention further relates to a process for clarifying and stabilizing liquid foods by adding to the cloudy liquid food, or to the liquid food which has a tendency to cloud, an amount sufficient for clarification of a silica sol defined as above, and removing this again after the clarification.

In the inventive process, preferably use is made of aqueous suspensions of colloidal anionic silica sols having a silica sol content of more than 5% by weight, in particular 10%.

Preferred particle diameters of the silica sols are between 6 and 50 nm, in particular from 8 to 35 nm.

The pH of the colloidal anionic silica sols is preferably between 2 and 5, in particular from 2 to 4.

The particles of the suspensions of colloidal anionic silica sols of acid pH are preferably individualized particles of colloidal silica sols which are not bound to one another by siloxane bonds. Siloxane bonds are here taken to mean Si—O—Si bonds.

The surface area of the colloidal anionic silica sols is preferably between 60 and 500 m²/g.

The colloidal anionic silica sols of acid pH can be produced, for example, by freeing a corresponding silica sol of a basic pH from cations via a cation-exchange resin. This then immediately produces a colloidal anionic acid silica sol.

The liquid foods which can be clarified and stabilized according to the invention are, for example, fruit juice, beer or wine.

The present invention relates very particularly preferably to a process for clarifying and stabilizing fermented and unfiltered beer, in which process to a fermented and unfiltered beer is added an aqueous suspension of colloidal silica sol of acid pH, as has been defined above, and flocculation allowed to proceed, and the sediment formed is then removed so that a clear beer of good stability having a sodium content identical to the unclarified beer is obtained.

In a further preferred embodiment, the clarification and stabilization of liquid foods is carried out in the inventive process in such a manner that, apart from the silica sol, polyvinylpyrrolidone is also added, preferably in powder form. Polyvinylpyrrolidone is particularly very suitable for removing polyphenols.

To clarify and stabilize liquid foods, preferably 5 to 500 g/hectoliter, in particular 20 to 100 g, and especially 25 to 100 g/hectoliter of the silica sol are added to the unclarified food.

### EXAMPLES

In the examples, use was made of a colloidal, anionic acidic silica sol which is available under the name Klebosol® (Clariant France). It is characterized as follows:

| | | |
|---|---|---|
| SiO₂ content: | 10% | by weight |
| Na₂O content: | 0.02% | by weight |
| Specific surface area: | 280 | m²/g. |
| Mean particle diameter: | 9 | nm |
| pH (20° C.): | 3 | |
| Density (20° C.): | 1.058 | g/cm³ |

50 g/hl of acidic Klebosol were metered into the beer during transfer into the storage tank. After a storage time of six weeks, the beer was filtered through a combination layer filter. In parallel to this inventive example, as a comparative example a further beer which was produced according to the same production parameters and from the same malt batch was studied. 60 g/hl of xerogel were added to this beer during filtration. Both beers were in addition stabilized with 20 g/hl of PVPP.

During the filtration, no differences were found with respect to pressure rise or cloud. The analytical data of the filtered and unfiltered beers are shown in Table 1.

The head retention was determined according to Ross & Clark: Introducing CO₂ produces a certain foam volume. The index for head retention used is the mean lifetime of foam bubbles, which is determined from the ratio between the foam decomposition time and the logarithm of the ratio between the volume of the decomposed foam and of that still present.

TABLE 1
Analytical data of the experimental filtration

| | Comparative | | Inventive example | |
|---|---|---|---|---|
| | example | | unfiltrate + | filtrate + |
| Analyses | unfiltrate | filtrate | Klebosol | Klebosol |
| Original extract | 11.95 | 12.0 | 11.95 | 11.82 |
| % by weight | | | | |
| Alcohol % by | 5.35 | 5.40 | 5.40 | 5.35 |
| volume | | | | |
| Output - apparent | 86 | 86 | 86 | 86 |
| degree of | | | | |
| fermentation % | | | | |
| pH | 4.35 | 4.42 | 4.35 | 4.36 |
| Ross & Clark | 111 | 107 | 116 | 110 |
| head retention | | | | |
| Sodium mg/l | 11.8 | 12.5 | 14.5 | 14.2 |
| Tannoids mg/l | 43 | 19 | 50 | 16 |
| Total | 186 | 165 | 198 | 165 |
| polyphenols mg/l | | | | |
| MgSO₄-precipitable | 16.8 | 16.1 | 17.3 | 16.5 |
| nitrogen, mg/100 ml | | | | |
| Total oxygen mg/l | | 0.1 | | 0.1 |

Unfiltrate is taken to mean here beer before filtration.

Differences may be recognized in head retention, sodium content, tannoids, total polyphenols, MgSO₄-precipitable nitrogen, and warm days, whereas the remaining values are virtually identical.

The foam points of the inventively treated beer are improved compared with the comparison example not only in the unfiltrate but also in the filtrate. The amounts of MgSO₄-precipitable nitrogen are slightly higher than in the comparative example. The sodium content of the inventively treated beer increased by about 2 mg/l. The amount of tannoids of the inventively produced unfiltrate is slightly higher than the comparison unfiltrate. In the filtrate, in contrast, no differences were observed. The amounts of total polyphenols behaved similarly.

In a further experiment, the number of warm days in the forcing test were determined. This is a measurement of the cloud intensity as a function of time. First the cloud is measured at room temperature. Then the sample is stored for 24 hours at 40° C., then for 24 hours at 0C. Thereafter the cloud is determined again. One cycle of storage at 40° C. and storage at 0° C. is termed one warm day. The cycle is repeated until the cloud has exceeded 2.5 European Brewery Convention (EBC) units.

Here, 3 beers were studied. In addition to the abovementioned beers which have been treated once with Xerogel and once with acid Klebosol, here for comparison purposes one beer is studied which had been treated with neutral Klebosol (pH≈7). The results are given in Table 2.

TABLE 2
Cloud as a function of storage time at 40° C.

| | Cloud/European Brewery Convention | | |
|---|---|---|---|
| | Beers with | | |
| | acidic | Beer with | Beer with neutral |
| Storage time/ | Klebosol | Xerogel | Klebosol |
| warm days | (inventive) | (comparison) | (comparison) |
| 0 | 0.4 | 0.4 | 0.4 |
| 2 | 0.4 | 0.5 | 0.7 |
| 5 | 0.4 | 0.6 | 1.1 |
| 7 | 0.4 | 0.7 | 1.8 |
| 10 | 1.0 | 1.7 | 2.6 |
| 12 | 1.5 | 2.7 | n.d. |
| 15 | 2.0 | n.d. | n.d. |

Whereas the beer treated with acidic Klebosol still had acceptable cloud after 15 days, in the Xerogel-treated beer, after 15 days, and in the neutral-Klebosol-treated beer, as soon as after 12 days, the cloud had become so intense that it had exceeded the measurement limit.

1. A method for clarifying and stabilizing liquid foods comprising adding to the liquid foods colloidal, anionic silica sols of a pH of 1 to 4, a particle diameter of 4 to 150 nm and a surface area of 20 to 700 m²/g.

2. The method as claimed in claim 1, wherein an aqueous suspension of colloidal anionic silica sols having a silica sol content of more than 5% by weight is used.

3. The method as claimed in claim 1, wherein the particle diameter of the silica sols used is between 6 and 50 nm.

4. The method as claimed in claim 1, wherein the pH of the silica sols used is between 2 and 4.

5. The method as claimed in claim 1, wherein the surface area of the silica sols used is between 60 and 500 m²/g.

6. The method as claimed in claim 1, wherein the liquid food is fruit juice, beer or wine.

7. The method as claimed in claim 1, wherein a polyvinylpyrrolidone is added to the silica sol.

8. The method as claimed in claim 1, wherein the amount of silica sols added is 5 to 500 g/hectoliter.

9. The method as claimed in claim 1, wherein the particle diameter of the silica sols used is between 8 and 35 nm.

10. A process for clarifying and stabilizing liquid foods comprising: adding to a cloudy liquid food, or to a liquid food which has a tendency to cloud, a sufficient amount of colloidal, anionic silica sols having a pH of 1 to 4, a particle diameter of 4 to 150 nm and a surface area of 20 to 700 m²/g to clarify the liquid foods; and removing the silica sol after clarifying the liquid foods.

11. The process as claimed in claim 10, wherein an aqueous suspension of colloidal anionic silica sols is used having a silica sol content of more than 5% by weight.

12. The process as claimed in claim 10, wherein the particle diameter of the silica sols used is between 6 and 50 nm.

13. The process as claimed in claim 10, wherein the particle diameter of the silica sols used is between 8 and 35 nm.

14. The process as claimed in claim 10, wherein the surface area of the silica sols used is between 60 and 500 m²/g.

15. The process as claimed in claim 10, wherein the liquid food is fruit juice, beer or wine.

16. The process as claimed in claim 10, wherein a polyvinylpyrrolidone is added to the silica sol.

17. The process as claimed in claim 10, wherein the amount of silica sols added is 5 to 500 g/hectoliter.

18. The process as claimed in claim 10, wherein the pH of the silica sols used is between 2 and 4.

19. A process for clarifying and stabilizing fermented and unfiltered beer comprising: adding to a fermented and unfiltered beer a sufficient amount of an aqueous suspension of colloidal, anionic silica sols having a pH of 1 to 4, a particle diameter of 4 to 150 nm and a surface area of 20 to 700 m²/g; allowing flocculation to proceed; and removing any formed sediment, whereby a clear beer of good stability having a sodium content identical to the unclarified beer is obtained.

20. The process as claimed in claim 19, wherein the aqueous suspension of colloidal anionic silica sols used has a silica sol content of more than 5% by weight.

21. The process as claimed in claim 19, wherein the particle diameter of the silica sols used is between 6 and 50 nm.

22. The process as claimed in claim 19, wherein the particle diameter of the silica sols used is between 8 and 35 nm.

23. The process as claimed in claim 19, wherein the surface area of the silica sols used is between 60 and 500 m²/g.

24. The process as claimed in claim 19, wherein a polyvinylpyrrolidone is added to the silica sol.

25. The process as claimed in claim 19, wherein the amount of silica sols added is 5 to 500 g/hectoliter.

26. The process as claimed in claim 19, wherein the pH of the silica sols used is between 2 and 4.
